(19) United States
(12) Patent Application Publication
(10) Pub. No.: US 2015/0002108 A1
(43) Pub. Date: Jan. 1, 2015

(54) BRIDGELESS POWER FACTOR CORRECTION BOOST CONVERTER

(71) Applicant: Hyundai Motor Company, Seoul (KR)

(72) Inventor: Jong Pil Kim, Gwacheon (KR)

(73) Assignee: HYUNDAI MOTOR COMPANY, Seoul (KR)

(21) Appl. No.: 14/044,197

(22) Filed: Oct. 2, 2013

(30) Foreign Application Priority Data
Jun. 28, 2013 (KR) 10-2013-0075163

(51) Int. Cl. H02M 1/42

(52) U.S. Cl. CPC H02M 1/4208
USPC 323/210

(57) ABSTRACT

A bridgeless power factor correction (PFC) boost converter is provided that includes a first circuit, an output terminal, a second circuit, and a controller. The first circuit includes a first inductor, a first switch, and a first inductor switch. The output terminal is connected in parallel to the first switch. The second circuit includes a second inductor, a second switch and a second inductor switch, and the second switch is connected in parallel to the output terminal. The controller is configured to turn on the first inductor switch and boost the output terminal by turning the first switch on and off when the positive phase of the AC power source is input, and turn on the second inductor switch and boosts the output terminal by turning the second switch on and off when the negative phase of the AC power source is input.

### CROSS-REFERENCE TO RELATED APPLICATION

This application claims under 35 U.S.C. §119(a) priority to Korean Patent Application No. 10-2013-0075163 filed on Jun. 28, 2013, the entire contents of which are incorporated herein by reference.

### BACKGROUND

1. Field of the Invention

The present invention relates to an alternating current (AC) rectifier stage (full-wave rectifier stage) of an AC-direct current (DC) converter using AC power as input and a power factor correction (PFC) boost converter.

2. Description of the Related Art

In a conventional bridge diode and PFC boost converter structure, bridge diodes are used to convert AC power input into a same polarity (full-wave rectification), and a PFC booster circuit performs factor correction and boosting via the bridge diodes. However, for high current, an increase in conduction loss occurs due to a voltage drop in a forward direction of the bridge diodes, thereby reducing the overall efficiency significantly, and the size of the converter increases due to the heat radiation and package configuration of the bridge diodes, which result from the loss attributable to the bridge diodes.

In a bridgeless PFC converter, electromagnetic interference (EMI) and PFC current voltage and input voltage sensing errors occur due to the ground (GND) floating of a PFC boost stage. This bridgeless PFC converter may be disadvantageous for high-capacity application due to an increase in the stress of PFC switch devices and a decrease in efficiency, resulting from the formation of a loop through the body diodes of turned-off interval switches.

Furthermore, in a phase shift semi-bridgeless converter, a space of diode paths occurs due to the addition of the ON/OFF intervals of a PFC boost stage, the configuration of control may be more complex due to the floating of an Field Effect Transistor (FET) gate, and the efficiency gain is lower than that of a conventional converter due to a decrease in efficiency.

The present invention is directed to the topology of an AC-DC PFC boost converter using AC power as input. In this AC-DC PFC boost converter, bridge diodes may be eliminated to eliminate the full-wave rectifier units of the bridge diodes and a boost converter A may be operated in a positive phase and a boost converter B may be operated in a negative phase. To limit a current loop between live and neutral states, a zero-voltage switching synchronous circuit may be applied.

The above descriptions of the related art are intended merely to help understanding of the related art of the present invention, and the related art should not be construed as being admitted to be prior art by those having ordinary knowledge in the technical field to which the present invention pertains.

### SUMMARY

The present invention provides an AC rectifier stage (e.g., full-wave rectifier stage) of an AC-DC converter using AC power as input and a power factor correction (PFC) boost converter.

In accordance with an aspect of the present invention, a PFC boost converter may include a first circuit that may have a first inductor, a first switch, and a first inductor switch connected to an AC power source; an output terminal connected in parallel to the first switch of the first circuit via a first diode; a second circuit that may have a second inductor, a second switch and a second inductor switch connected to the AC power source, the second switch being connected in parallel to the output terminal via a second diode; and a controller configured to turn on the first inductor switch and boost the output terminal by turning the first switch on and off when a positive phase of the AC power source is input, and configured to turn on the second inductor switch and boost the output terminal by turning the second switch on and off when a negative phase of the AC power source is input.

The controller may be configured to turn off the second inductor switch when the positive phase of the AC power source is input. In addition, the controller may be configured to turn off the first inductor switch when the negative phase of the AC power source is input. The controller may be configured to turn on the first inductor switch, and turn on the first switch to accumulate energy in the first inductor or turn off the first switch to deliver energy of the first inductor accumulated in the output terminal when the positive phase of the AC power source is input. Further, the controller may be configured to turn on the second inductor switch and turn on the second switch to accumulate energy in the second inductor or turn off the second switch to deliver energy of the second inductor accumulated in the output terminal when the negative phase of the AC power source is input.

In accordance with another aspect of the present invention, a bridgeless PFC boost converter may include a first circuit that may have a first inductor, a first switch and a first inductor switch connected to an AC power source; an output terminal connected in parallel to the first switch of the first circuit via a first auxiliary switch; a second circuit that may include a second inductor, a second switch and a second inductor switch connected to the AC power source, the second switch being connected in parallel to the output terminal via a second auxiliary switch; and a controller configured to turn on the first inductor switch and boost the output terminal by turning the first switch and the first auxiliary switch on and off when a positive phase of the AC power source is input, and configured to turn on the second inductor switch and boost the output terminal by turning the second switch and the second auxiliary switch on and off when a negative phase of the AC power source is input.

### BRIEF DESCRIPTION OF THE DRAWINGS

The above and other objects, features and advantages of the present invention will be more clearly understood from the following detailed description taken in conjunction with the accompanying drawings, in which:

FIG. 1 is an exemplary circuit diagram of a bridgeless PFC boost converter in accordance with an exemplary embodiment of the present invention;

FIGS. 2 to 5 are exemplary diagrams illustrating the operation of the bridgeless PFC boost converter in accordance with the exemplary embodiment of the present invention; and

FIGS. 6 and 7 are exemplary circuit diagrams of bridgeless PFC boost converters in accordance with other exemplary embodiments of the present invention.

### DETAILED DESCRIPTION

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor. The memory is configured to store the modules and the processor is specifically configured to execute said modules to perform one or more processes which are described further below.

Furthermore, control logic of the present invention may be embodied as non-transitory computer readable media on a computer readable medium containing executable program instructions executed by a processor, controller/control unit or the like. Examples of the computer readable mediums include, but are not limited to, ROM, RAM, compact disc (CD)-ROMs, magnetic tapes, floppy disks, flash drives, smart cards and optical data storage devices. The computer readable recording medium can also be distributed in network coupled computer systems so that the computer readable media is stored and executed in a distributed fashion, e.g., by a telematics server or a Controller Area Network (CAN).

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Bridgeless PFC boost converters according to exemplary embodiments of the present invention will be described below with reference to the accompanying drawings.

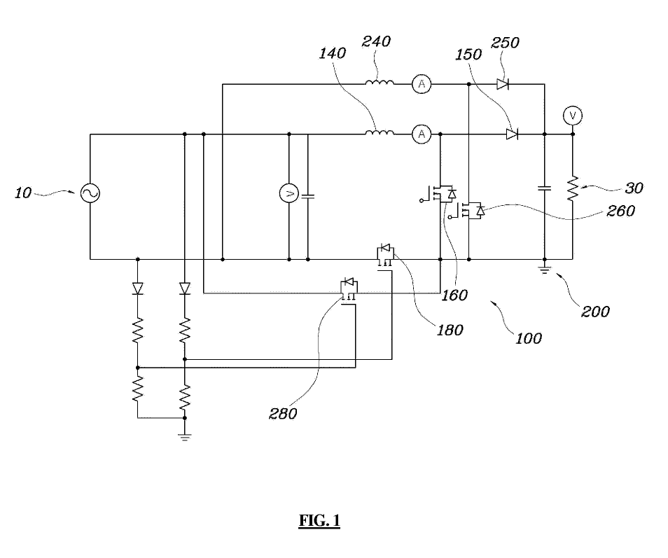

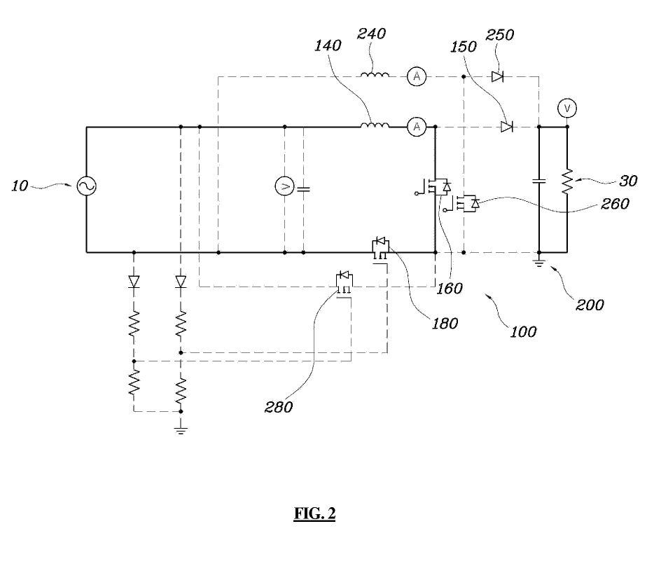

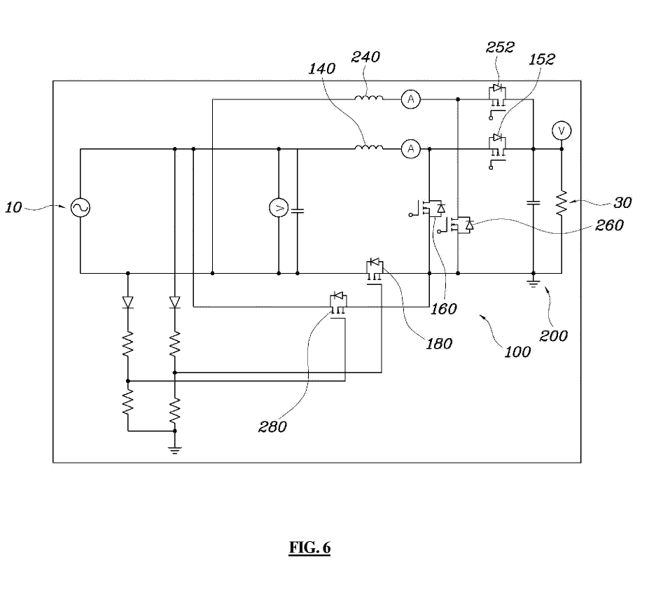

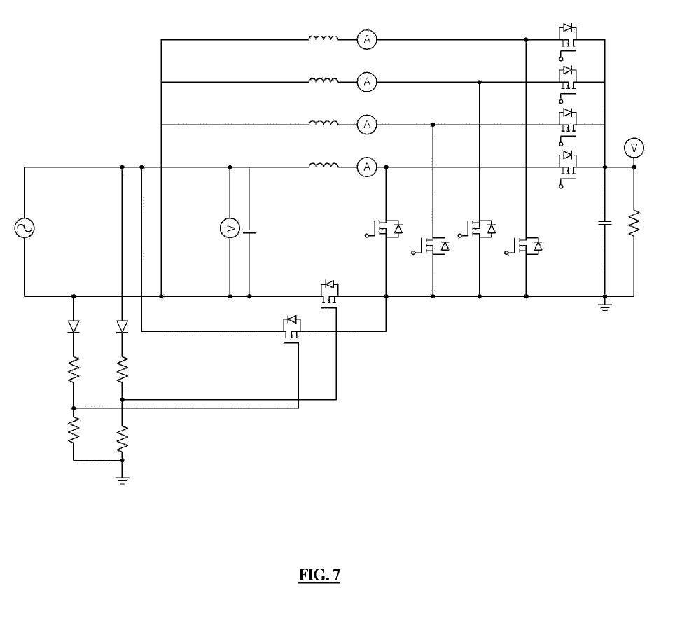

FIG. 1 is an exemplary circuit diagram of a bridgeless PFC boost converter in accordance with an exemplary embodiment of the present invention, FIGS. 2 to 5 are exemplary diagrams illustrating the operation of the bridgeless PFC boost converter in accordance with the exemplary embodiment of the present invention, and FIGS. 6 and 7 exemplary are circuit diagrams of bridgeless PFC boost converters in accordance with other exemplary embodiments of the present invention.

The bridgeless PFC boost converter may include a first circuit 100 that may have a first inductor 140, a first switch 160 and a first inductor switch 180 connected to an AC power source 10; an output terminal 30 may be connected in parallel to the first switch 160 of the first circuit 100 via a first diode 150; a second circuit 200 that may have a second inductor 240, a second switch 260 and a second inductor switch 280 connected to the AC power source 10, the second switch 260 may be connected in parallel to the output terminal 30 via a second diode 250; and a controller configured to turn on the first inductor switch 180 and boost the output terminal 30 by turning the first switch 160 on and off when the positive phase of the AC power source 10 is input, and configured to turn on the second inductor switch 280 and boost the output terminal 30 by turning the second switch 260 on and off when the negative phase of the AC power source 10 is input.

In other words, the first circuit 100 and the second circuit 200 may be connected to the AC power source 10 without bridge diodes to thereby have double inductors, and thus boosting may be achieved by performing alternate switching. Therefore, the bridgeless PFC boost converter according to the exemplary embodiment of the present invention may be provided with the first circuit 100 that may have the first inductor 140, the first switch 160 and the first inductor switch 180 that may be connected to an AC power source 10. Furthermore, the output terminal 30 may be connected in parallel to the first switch 160 of the first circuit 100 via the first diode 150. The second circuit 200 may include the second inductor 240, the second switch 260 and the second inductor switch 280 that may be connected to the AC power source 10, and the second switch 260 may be connected in parallel to the output terminal 30 via the second diode 250.

Furthermore, the controller (e.g., the controller that operates the switching devices, and is not shown in the drawing) may be configured to turn on the first inductor switch 180 and boost the output terminal 30 by turning the first switch 160 on and off when the positive phase of the AC power source 10 is input, and turn on the second inductor switch 280 and boost the output terminal 30 by turning the second switch 260 on and off when the negative phase of the AC power source 10 is input.

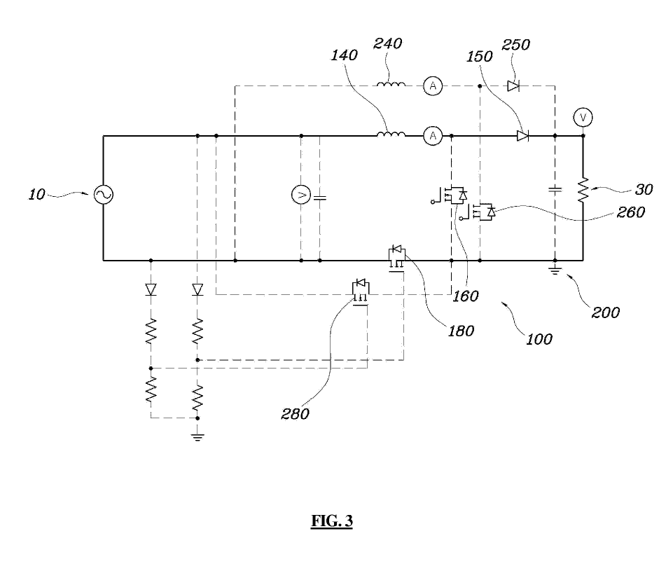

Accordingly, the controller may be configured to turn off the second inductor switch 280 when the positive phase of the AC power source 10 is input, and turn off the first inductor switch 180 when the negative phase of the AC power source 10 is input. More specifically, as shown in FIGS. 2 and 3, when the positive phase of the AC power source 10 is input, the controller may be configured to turn on the first inductor switch 180, and turn on the first switch 160 to accumulate energy in the first inductor 140 or turn off the first switch 160 to deliver the energy of the first inductor 140 accumulated in the output terminal 30.

Referring to FIG. 2, when the positive phase of the AC power source 10 above a ground reference is input, the first inductor switch 180 may be closed. In a positive interval, current may increase in the first inductor 140 and energy may be accumulated in the boost converter, during the ON time of the first switch 160. The ON operation may be performed along the loop of the first circuit 100 of the first inductor 140, the first inductor switch 180 and the first switch 160.

In FIG. 3, when the positive phase of the AC power source 10 above the ground reference is input, the first inductor switch 180 may be closed. In the positive interval, energy accumulated in the first inductor 140 may be delivered via the first diode 150 in the boost converter during the OFF time of the first switch 160. The OFF operation may be performed along the loop of the first inductor 140, the first diode 150 and the first inductor switch 180.

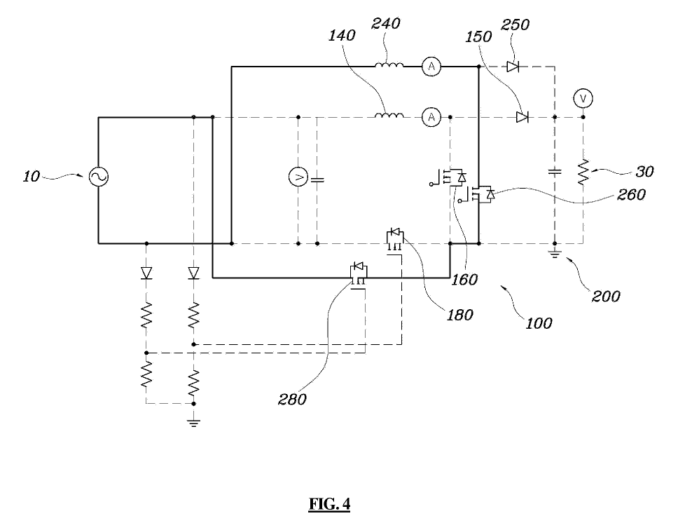

Moreover, when the negative phase of the AC power source 10 is input, the controller may be configured to turn on the second inductor switch 280, and turn on the second switch 260 to accumulate energy in the second inductor 240 or turn off the second switch 260 to deliver the energy of the second inductor 240 accumulated in the output terminal 30. In other words, in FIG. 4, when the negative phase of the AC power source 10 below the ground reference is input, the second inductor switch 280 may be closed. In a negative interval, current may increase in the second inductor 240 and energy may be accumulated in the boost converter, during the ON time of the second switch 260. The ON operation may be performed along the loop of the second circuit 200 of the second inductor 240, the second inductor switch 280 and the second switch 260.

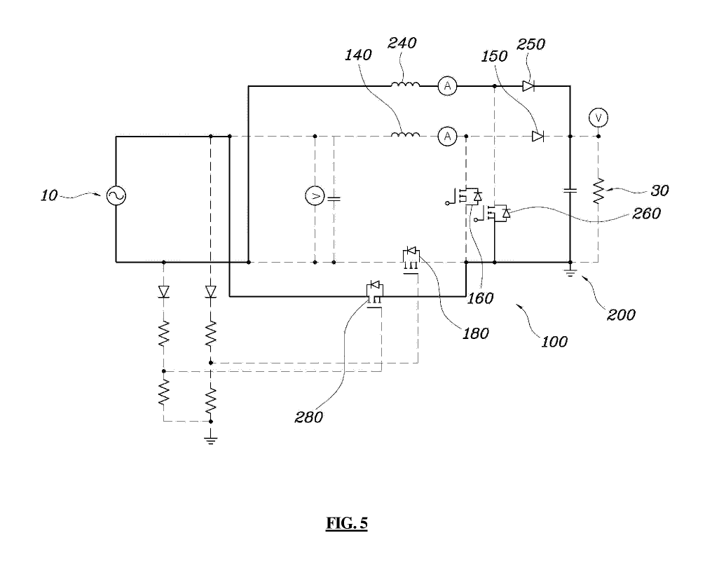

In FIG. 5, when the negative phase of the AC power source 10 below the ground reference is input, the second inductor switch 280 may be closed. In the negative interval, energy accumulated in the second inductor 240 may be delivered via the second diode 250 in the boost converter during OFF time. The OFF operation may be performed along the loop of the second inductor 240, the second diode 250 and the second switch 260.

The bridgeless PFC boost converter according to another exemplary embodiment of the present invention may include a first circuit 100 that may have a first inductor 140, a first switch 160 and a first inductor switch 180 connected to an AC power source 10; an output terminal 30 may be connected in parallel to the first switch 160 of the first circuit 100 via a first auxiliary switch 152; a second circuit 200 that may have a second inductor 240, a second switch 260 and a second inductor switch 280 connected to the AC power source 10, the second switch 260 may be connected in parallel to the output terminal 30 via a second auxiliary switch 252; and a controller configured to turn on the first inductor switch 180 and boost the output terminal 30 by turning the first switch 160 and the first auxiliary switch 152 on and off when the positive phase of the AC power source 10 is input, and configured to turn on the second inductor switch 280 and boost the output terminal by turning the second switch 260 and the second auxiliary switch 252 on and off when the negative phase of the AC power source 10 is input.

Therefore, transistor switches may be used instead of diodes, as illustrated in FIG. 6. In particular, when the positive phase of the AC power source is input, the first inductor switch may be turned on, and the output terminal may be boosted by turning on and off the first switch and the first auxiliary switch. When the negative phase of the AC power source is input, the second inductor switch may be turned on and the output terminal may be boosted by turning on and off the second switch and the second auxiliary switch.

Moreover, when three-phase AC power is applied, an implementation may be made to perform boosting, as illustrated in FIG. 7. In particular, all three phases should be taken into consideration. The control of the three phases may be enabled by adding two circuit lines each including an inductor, an inductor switch, a switch, and a diode. This implementation may also utilize auxiliary switches instead of the diodes.

In accordance with the bridgeless PFC boost converters configured as described above, an increase in efficiency may be achieved due to a decrease in loss that corresponds to a voltage drop in the forward direction of bridge diodes, which results from the elimination of the bridge diodes. The elimination of a heat radiation space and the reduction in the converter volume may be enabled due to the elimination of the bridge diodes and the decrease in loss. In addition, a decrease in the stress of the PFC boost devices and the construction of a heat radiation configuration may be facilitated by performing alternate switching according to the AC frequency.

Although the exemplary embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A bridgeless power factor correction (PFC) boost converter, comprising:
a first circuit that includes a first inductor, a first switch, and a first inductor switch connected to an alternating current (AC) power source;
an output terminal connected in parallel to the first switch of the first circuit via a first diode;
a second circuit that includes a second inductor, a second switch and a second inductor switch connected to the AC power source, wherein the second switch is connected in parallel to the output terminal via a second diode; and
a controller configured to:
turn on the first inductor switch and boost the output terminal by turning the first switch on and off when a positive phase of the AC power source is input; and
turn on the second inductor switch and boost the output terminal by turning the second switch on and off when a negative phase of the AC power source is input.

2. The bridgeless PFC boost converter of claim 1, wherein the controller is configured to turn off the second inductor switch when the positive phase of the AC power source is input.

3. The bridgeless PFC boost converter of claim 1, wherein the controller is configured to turn off the first inductor switch when the negative phase of the AC power source is input.

4. The bridgeless PFC boost converter of claim 1, wherein the controller is configured to turn on the first inductor switch and turn on the first switch to accumulate energy in the first inductor or turn off the first switch to deliver energy of the first inductor accumulated in the output terminal when the positive phase of the AC power source is input.

5. The bridgeless PFC boost converter of claim 1, wherein the controller is configured to turn on the second inductor switch and turn on the second switch to accumulate energy in the second inductor or turn off the second switch to deliver energy of the second inductor accumulated in the output terminal when the negative phase of the AC power source is input.

6. A bridgeless PFC boost converter comprising:
a first circuit that includes a first inductor, a first switch and a first inductor switch connected to an AC power source;
an output terminal connected in parallel to the first switch of the first circuit via a first auxiliary switch;
a second circuit that includes a second inductor, a second switch and a second inductor switch connected to the AC power source, wherein the second switch is connected in parallel to the output terminal via a second auxiliary switch; and
a controller configured to:
turn on the first inductor switch and boost the output terminal by turning the first switch and the first auxiliary switch on and off when a positive phase of the AC power source is input; and
turn on the second inductor switch and boost the output terminal by turning the second switch and the second auxiliary on and off switch when a negative phase of the AC power source is input.

7. A bridgeless power factor correction (PFC) boost converter method, comprising:
turning on, by a controller, a first inductor switch of a first circuit, wherein the first inductor switch is connected to an alternating current (AC) power source;
boosting, by the controller, an output terminal connected in parallel to a switch of the first circuit via first diode by turning the first switch on and off when a positive phase of the AC power source is input;
turning on, by the controller, a second inductor switch of a second circuit, wherein the second inductor switch is connected to the AC power source; and
boosting, by the controller, the output terminal by turning a second switch on and off when a negative phase of the AC power source is input, wherein the second switch is connected in parallel to the output terminal via a second diode.

8. The method of claim 7, further comprising:
turning off, by the controller, the second inductor switch when the positive phase of the AC power source is input.

9. The method of claim 7, further comprising:
turning off, by the controller, the first inductor switch when the negative phase of the AC power source is input.

10. The method of claim 7, further comprising:
turning on, by the controller, the first inductor switch and turning on the first switch to accumulate energy in the first inductor or turning off the first switch to deliver energy of the first inductor accumulated in the output terminal when the positive phase of the AC power source is input.

11. The method of claim 7, further comprising:
turning on, by the controller, the second inductor switch and turning on the second switch to accumulate energy in the second inductor or turning off the second switch to deliver energy of the second inductor accumulated in the output terminal when the negative phase of the AC power source is input.

12. A non-transitory computer readable medium containing program instructions executed by a controller, the computer readable medium comprising:
program instructions that turn on a first inductor switch of a first circuit, wherein the first inductor switch is connected to an alternating current (AC) power source;
program instructions that boost an output terminal connected in parallel to a switch of the first circuit via first diode by turning the first switch on and off when a positive phase of the AC power source is input;
program instructions that turn on a second inductor switch of a second circuit, wherein the second inductor switch is connected to the AC power source; and
program instructions that boost the output terminal by turning a second switch on and off when a negative phase of the AC power source is input, wherein the second switch is connected in parallel to the output terminal via a second diode.

13. The non-transitory computer readable medium of claim 12, further comprising:
program instructions that turn off the second inductor switch when the positive phase of the AC power source is input.

14. The non-transitory computer readable medium of claim 12, further comprising:
program instructions that turn off the first inductor switch when the negative phase of the AC power source is input.

15. The non-transitory computer readable medium of claim 12, further comprising:
program instructions that turn on the first inductor switch and turning on the first switch to accumulate energy in the first inductor or turning off the first switch to deliver energy of the first inductor accumulated in the output terminal when the positive phase of the AC power source is input.

16. The non-transitory computer readable medium of claim 12, further comprising:
program instructions that turn on the second inductor switch and turning on the second switch to accumulate energy in the second inductor or turning off the second switch to deliver energy of the second inductor accumulated in the output terminal when the negative phase of the AC power source is input.
